(19) United States
(12) Patent Application Publication
(10) Pub. No.: US 2026/0311257 A1
(43) Pub. Date: Oct. 8, 2026

(54) Optimization Engine For Multi-Investor Portfolio Aggregation

(71) Applicant: ExchangiFi LLC, Palm Beach Gardens, FL (US)

(72) Inventors: Matthew H. Bucklin, Palm Beach Gardens, FL (US); Ricardo Velasquez Munera, Palm Beach Gardens, FL (US); Juan David Trujillo Suarez, Plantation, FL (US)

(21) Appl. No.: 19/639,194

(22) Filed: Apr. 4, 2026

Related U.S. Application Data
(60) Provisional application No. 63/783,643, filed on Apr. 4, 2025.

(51) Int. Cl. G06Q 40/06; G06Q 40/10

(52) U.S. Cl. CPC G06Q 40/062; G06Q 40/064; G06Q 40/10

(57) ABSTRACT

A computer-implemented method for optimizing a contribution portfolio for a tax-deferred securities exchange includes receiving portfolio data comprising positions, quantities, and tax-lot cost-basis records from financial accounts. Look-through analysis is performed on pooled investment vehicles to retrieve constituent holdings and calculate the investor's proportionate interest in underlying securities. Tax lots are aggregated into a consolidated view sorted by cost basis from lowest to highest. A portfolio optimization algorithm iteratively selects tax lots in ascending order of cost basis and adds each to a proposed contribution basket, evaluating diversification constraints including single-security and top-securities concentration constraints after each addition. When a tax lot addition violates a constraint, the algorithm removes the tax lot and proceeds to a next lowest-cost-basis tax lot of a different security. Optimized share quantities are redistributed to originating accounts, and a securities-transfer instruction file is generated for transmission to a custodian.

### CROSS-REFERENCE TO RELATED APPLICATIONS

This application claims the benefit of U.S. Provisional Patent Application No. 63/783,643, filed Apr. 4, 2025, which is incorporated by reference.

### FIELD OF INVENTION

This disclosure relates to automated financial technology systems for investment portfolio optimization, and more particularly to a multi-module platform for optimizing contribution portfolios, assembling completion portfolios from multiple investor holdings, and automating fund formation in connection with tax-deferred securities exchanges.

### BACKGROUND

Investment portfolio management systems have evolved to address various aspects of wealth management, including portfolio rebalancing, asset allocation, and tax optimization. However, one of the primary challenges in this field involves coordinating portfolio optimization across multiple investors when those investors seek to contribute securities to a pooled investment vehicle while deferring capital gains recognition.

One example of this challenge arises when ensuring compliance with statutory requirements such as 26 U.S.C. § 351, which permits shareholders to contribute appreciated securities to a corporation in exchange for shares while deferring recognition of capital gains, provided certain conditions are met.

Conventional portfolio management systems are typically designed to rebalance individual accounts against a static benchmark or to aggregate assets into existing funds through liquidation transactions. These systems treat portfolio optimization as a single-investor problem, where one investor's holdings are evaluated against one target allocation and a single set of constraints is applied. When multiple investors must simultaneously contribute securities to a single pooled vehicle—each subject to independent regulatory diversification constraints and each seeking to maximize individual tax deferral—existing systems encounter difficulties in solving the resulting coupled optimization problem. The coupling arises because each investor's contribution changes the aggregate fund composition, which alters the residual benchmark deficit, which in turn changes the optimal contribution for every other investor.

Systems that attempt to address multi-investor portfolio assembly often do so by solving each investor's contribution independently and then checking fund-level feasibility after the fact. This sequential approach may produce fund-level portfolios that violate aggregate concentration limits, requiring manual intervention and iterative rework. Additionally, such approaches may leave tax-deferral value unrealized because they cannot trade off one investor's marginal deferral against another's benchmark contribution.

Another challenge involves the handling of pooled investment vehicles within investor portfolios. Investors may hold exchange-traded funds, mutual funds, closed-end funds, and other pooled vehicles that contain underlying securities. Determining the investor's effective exposure to individual securities requires look-through analysis to identify constituent holdings and calculate proportionate interests. Existing systems may lack the capability to perform this analysis across multiple accounts and aggregate the results at the tax-lot level.

Manual processes for executing tax-deferred securities exchanges have historically required substantial effort by wealth advisors, tax counsel, compliance officers, and fund administrators working across multiple spreadsheets and proprietary systems. Manual data entry and calculations are prone to errors, which can lead to compliance issues and financial inaccuracies. As the volume of potential exchanges increases, manual methods may not efficiently scale to handle larger workloads without a proportional increase in resources.

Standard heuristic or linear-rule-based optimization engines may encounter difficulties when the number of security-lot variables increases, potentially leading to sub-optimal portfolio compositions that either fail to satisfy regulatory requirements or result in significant tracking error against target benchmarks. The transformation of high-cardinality, non-homogeneous tax-lot data into a format suitable for real-time, multi-objective optimization presents computational challenges that existing database and processing architectures may not adequately address.

Therefore, improved systems and methods for multi-investor portfolio optimization, completion portfolio assembly, and automated fund formation are desirable.

### SUMMARY

The described embodiments provide methods and systems for optimizing contribution portfolios, assembling completion portfolios from multiple investor holdings, and automating fund formation in connection with tax-deferred securities exchanges. These systems and methods enhance portfolio optimization by coordinating across multiple investors simultaneously, enforcing diversification constraints at both individual and fund levels, and maximizing tax deferral while minimizing tracking error against target benchmarks.

In various embodiments, a portfolio optimization and compliance engine receives portfolio data for an investor from a plurality of financial accounts, performs look-through analysis on pooled investment vehicles to identify underlying securities, aggregates tax lots across all accounts, checks current market prices to determine market value for all securities, and executes a portfolio optimization algorithm that iteratively selects tax lots in ascending order of cost basis. The portfolio optimization and compliance engine adds each selected tax lot to a proposed contribution basket and evaluates diversification constraints after each addition. When a tax lot addition violates a diversification constraint, the portfolio optimization and compliance engine removes the tax lot from the proposed contribution basket and proceeds to a next lowest-cost-basis tax lot of a different security. The portfolio optimization and compliance engine then redistributes optimized share quantities to originating accounts and generates a securities-transfer instruction file for transmission to a financial custodian.

In alternative embodiments, the portfolio optimization and compliance engine may apply an overweight-position concentration constraint requiring that all positions individually exceeding a threshold of the total portfolio market value must in aggregate constitute less than another threshold of the total portfolio market value. The diversification constraints may include a single-security concentration constraint of, for example, 25% of the total portfolio market value, a top-five securities concentration constraint of, for example, 50% of the total portfolio market value, or other configurable thresholds. The system may receive investor-specified concentration thresholds below default diversification constraint limits and re-execute the portfolio optimization algorithm subject to the investor-specified thresholds. The system may calculate unrealized capital gains for each tax lot and estimate tax liability that would result from a taxable sale. The system may present the securities-transfer instruction file to a wealth advisor for electronic approval prior to transmission. The system may evaluate the optimized contribution portfolio against sponsor-defined security eligibility rules, accept compliant portfolio components, flag prohibited securities, and re-optimize the contribution portfolio using only accepted securities to generate a reduced but compliant contribution portfolio.

In various embodiments, a completion portfolio matchmaking engine assembles a completion portfolio for a new investment fund from securities held across a plurality of investor portfolios. The completion portfolio matchmaking engine receives a target portfolio specification from a fund sponsor comprising target securities, target weightings, permitted securities, and prohibited securities. The completion portfolio matchmaking engine receives investor portfolio data from a plurality of investors, each investor portfolio comprising tax lots with security identifiers, share quantities, and cost-basis values. The completion portfolio matchmaking engine solves a master problem that tracks fund-level benchmark adherence and fund-level diversification constraints by computing optimal column weights and extracting dual prices for each security. The completion portfolio matchmaking engine transmits the dual prices to a plurality of subproblem solvers, wherein each subproblem solver is assigned to a respective investor. Each subproblem solver solves an investor subproblem in parallel that generates a candidate contribution portfolio for the assigned investor, maximizing a tax-deferral objective modified by the dual prices such that securities overrepresented at a fund level are penalized and securities underrepresented at the fund level are favored. The completion portfolio matchmaking engine evaluates whether any candidate contribution portfolio has a reduced cost exceeding a convergence threshold, adds improving candidate contribution portfolios to a column pool of the master problem, and repeats solving the master problem until convergence. Upon convergence, the completion portfolio matchmaking engine enforces integrality constraints by selecting contribution portfolios for each investor and outputs per-investor contribution schedules and an assembled completion portfolio.

In alternative embodiments, the completion portfolio matchmaking engine may apply fund-level and investor-level diversification constraints comprising concentration requirements applied independently at each level. The completion portfolio matchmaking engine may linearize self-referential percentage-based diversification constraints by algebraic rearrangement. The completion portfolio matchmaking engine may compute a strategy alignment score expressing a percentage similarity between the assembled completion portfolio and a sponsor-defined benchmark portfolio. The completion portfolio matchmaking engine may perform dominance pruning by identifying dominated tax lots and excluding them from investor subproblems. The completion portfolio matchmaking engine may maintain a constraint margin vector that tracks current slack for each active constraint at both investor and fund levels. Each investor subproblem may warm-start with a solution from a previous iteration.

In various embodiments, a fund formation and share-issuance module automates investment fund formation in connection with a tax-deferred securities exchange. The fund formation and share-issuance module receives a completion portfolio comprising securities contributed by a plurality of investors with associated tax-lot cost-basis records. The fund formation and share-issuance module calculates a total number of new fund shares to issue by dividing an aggregate market value of all contributed securities by a target net asset value per share. The fund formation and share-issuance module allocates new fund shares to each investor in proportion to a market value of that investor's contributed securities relative to the aggregate market value. The fund formation and share-issuance module generates securities-transfer instructions directing delivery of allocated new fund shares to each investor's designated account. The fund formation and share-issuance module remaps cost basis from contributed securities to newly issued fund shares by assigning, to each investor's allocated fund shares, a cost basis corresponding to an original total cost basis for each tax lot of securities contributed by that investor, thereby preserving a deferred gain in the new fund shares. The fund formation and share-issuance module records cost-basis information at a fund level for each contributed security to establish the fund's initial tax basis in completion portfolio positions.

In alternative embodiments, the fund formation and share-issuance module may generate an audit trail record comprising transaction records, allocation records, cost-basis assignments, and transfer instructions for regulatory compliance purposes. The fund formation and share-issuance module may generate a per-investor record comprising allocated fund shares, original contributing tax lots, associated cost-basis information, and transfer-instruction details. The fund formation and share-issuance module may validate that a control group of contributing investors collectively owns at least a threshold ownership percentage of the new fund shares immediately after the exchange. The fund formation and share-issuance module may format transfer data according to requirements of a destination custodian account and transmit the securities-transfer instructions to initiate delivery of new fund shares.

The disclosed embodiments provide technical improvements by reducing the computational overhead required to process multi-investor portfolios against a benchmark through a column-generation decomposition architecture that converts a monolithic optimization problem into a sequence of tractable smaller problems. The dual-price coordination mechanism enables independent, parallelizable investor-level subproblems whose solutions converge toward a globally coordinated optimum. The constraint linearization transforms self-referential percentage-based diversification constraints into linear inequalities, eliminating the need for general nonlinear solvers and enabling the use of mature linear and quadratic programming solver technology. These features enable the execution of complex multi-party exchanges that would be computationally infeasible through manual or general-purpose computing methods.

The completion portfolio matchmaking engine implements a multi-objective optimization within the master problem to balance fund-level benchmark adherence with aggregate tax efficiency across participating investors. To minimize fund-level tracking error, the system utilizes the dual-price coordination mechanism to penalize securities that are overrepresented relative to the target benchmark, effectively signaling the subproblems to favor the acquisition of underweight securities. Simultaneously, each investor-level subproblem maximizes deferred capital gains by prioritizing low-cost-basis tax lots for contribution, weighing the individual tax-deferral benefit against the dual-price penalty for securities the fund does not need. The column-generation architecture iteratively identifies candidate contribution portfolios that satisfy the linearized diversification constraints at both investor and fund levels, enabling coordinated assembly of the completion portfolio while preserving tax-deferral value for each participating investor.

### BRIEF DESCRIPTION OF FIGURES

Non-limiting and non-exhaustive examples are described with reference to the following figures.

FIG. 1 illustrates a system overview of a tax-deferred investment platform, in accordance with one or more embodiments.

FIG. 2 illustrates a flowchart of a method for connecting wealth advisors and investors to tax-deferral strategies, in accordance with one or more embodiments.

FIG. 3 illustrates a flowchart of a method for optimizing a contribution portfolio, in accordance with one or more embodiments.

FIG. 4 illustrates a flowchart of a method for iterative tax-lot selection and constraint checking, in accordance with one or more embodiments.

FIG. 5 illustrates a flowchart of a method for capital-raising and portfolio acceptance, in accordance with one or more embodiments.

FIG. 6A illustrates a system architecture of a completion portfolio matchmaking engine, in accordance with one or more embodiments.

FIG. 6B illustrates a flowchart of a method for a column generation iteration cycle, in accordance with one or more embodiments.

FIG. 7 illustrates a flowchart of a method for fund formation and share issuance, in accordance with one or more embodiments.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

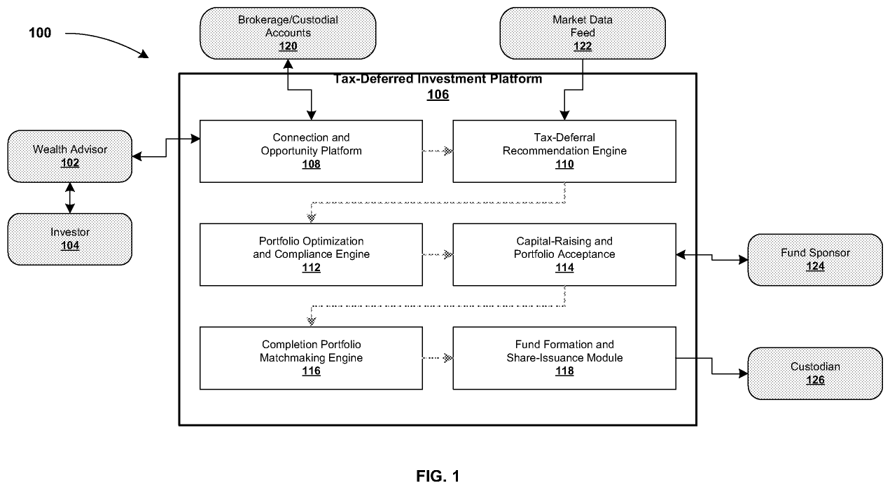

Referring to FIG. 1, a system 100 includes a tax-deferred investment platform 106 that provides an integrated multi-module architecture for tax-deferred investment strategy analysis, portfolio optimization, and fund formation. One example application of the tax-deferred investment platform 106 is facilitating securities exchanges that comply with statutory requirements such as 26 U.S.C. § 351. The tax-deferred investment platform 106 may reduce computational overhead by enabling coordinated data flow between specialized modules, where each module performs a discrete function while sharing data structures and intermediate results with other modules in the tax-deferred investment platform 106. The integrated architecture of the tax-deferred investment platform 106 may enable the execution of complex multi-party securities exchanges that involve simultaneous optimization across multiple investor portfolios.

The tax-deferred investment platform 106 comprises six integrated modules: a connection and opportunity platform 108, a tax-deferral recommendation engine 110, a portfolio optimization and compliance engine 112, a capital-raising and portfolio acceptance platform 114, a completion portfolio matchmaking engine 116, and a fund formation and share-issuance module 118. The connection and opportunity platform 108 may serve as an interface for connecting wealth advisors and investors to tax-deferral opportunities. The tax-deferral recommendation engine 110 may analyze linked portfolios to identify and quantify available tax-deferral strategies. The portfolio optimization and compliance engine 112 may determine securities and quantities to contribute to an exchange fund while enforcing diversification constraints. The capital-raising and portfolio acceptance platform 114 may enable fund sponsors to manage investor commitments and automate portfolio acceptance decisions. The completion portfolio matchmaking engine 116 may assemble a target completion portfolio from securities held across multiple investor portfolios while simultaneously generating individually compliant contribution portfolios for each participating investor. The fund formation and share-issuance module 118 may calculate share issuance counts, allocate shares to investors, generate custodian transfer instructions, and preserve and remap cost-basis records.

With continued reference to FIG. 1, the system 100 includes external entities that interact with the tax-deferred investment platform 106. A wealth advisor 102 may interface with an investor 104 and connect to the connection and opportunity platform 108. The connection and opportunity platform 108 may ingest portfolio data from brokerage/custodial accounts 120 via secure application programming interface (API) integrations. The portfolio data may include positions, quantities, cost basis, tax lot details, and account ownership information. A market data feed 122 may provide real-time pricing data to the tax-deferral recommendation engine 110 for establishing current market values of portfolio positions. A fund sponsor 124 may interact with the capital-raising and portfolio acceptance platform 114 to manage fundraising lifecycles and define security eligibility rules. The fund formation and share-issuance module 118 may output transfer instructions to a custodian 126 for initiating delivery of new fund shares to investor accounts. Internal data flow between modules of the tax-deferred investment platform 106 may enable coordinated processing of portfolio data, optimization results, and transfer instructions across the integrated architecture.

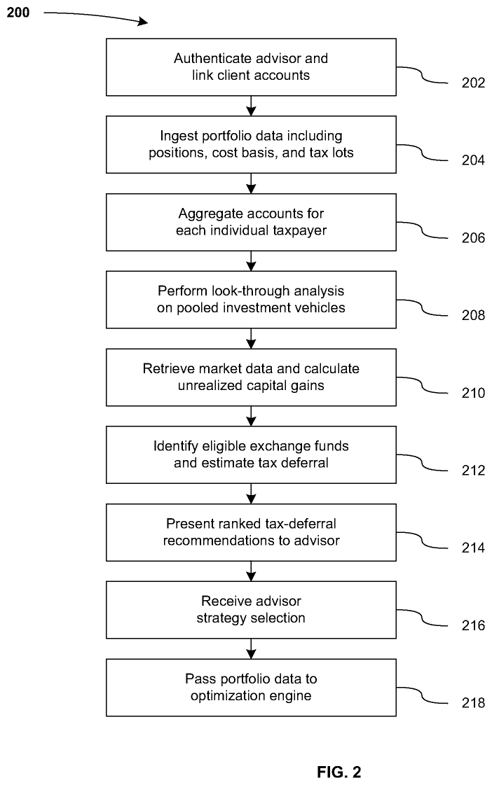

Referring to FIG. 2, a method 200 for connecting wealth advisors and investors to tax-deferral strategies may be performed by the connection and opportunity platform 108 and the tax-deferral recommendation engine 110 of the tax-deferred investment platform 106. The method 200 may enable wealth advisors to link investor accounts, analyze portfolio characteristics, and receive ranked tax-deferral recommendations through an automated workflow that reduces manual data entry errors and eliminates data fragmentation across multiple custodians.

At step 202, the method 200 authenticates a wealth advisor and links client brokerage and custodial accounts. The connection and opportunity platform 108 may authenticate the wealth advisor using secure authentication protocols including OAuth 2.0 authentication, which verifies the identity of users and applications accessing the system without requiring sharing of login credentials. The connection and opportunity platform 108 may require multi-factor authentication (MFA) to access custodian accounts through application programming interfaces (APIs), adding an additional layer of security by requiring multiple verification factors. Upon successful authentication, the connection and opportunity platform 108 may establish secure API connections to one or more brokerage and custodial accounts associated with the investor. The secure API connections may employ encryption protocols such as Transport Layer Security (TLS) or Secure Sockets Layer (SSL) to protect data both in transit between the client's custodian and the tax-deferred investment platform 106 and at rest within a secure environment. The use of secure API integrations may reduce manual data entry errors that occur when portfolio information is transcribed manually between systems.

At step 204, the method 200 ingests portfolio data from the linked accounts. The connection and opportunity platform 108 may retrieve portfolio data through the secure APIs provided by each custodian. The portfolio data may include positions, quantities, cost basis, tax lot details, and account ownership information, for one or multiple accounts per individual. The APIs may enable on-demand data retrieval, providing up-to-date information for subsequent processing. Each custodian may have a specific API structure, data formats, and security protocols, and the connection and opportunity platform 108 may normalize the disparate data formats from various brokerage platforms into a unified format for subsequent analysis.

With continued reference to FIG. 2, at step 206, the method 200 aggregates accounts for each individual taxpayer across all linked accounts. The tax-deferral recommendation engine 110 may aggregate data from multiple custodians into a consolidated view, eliminating data fragmentation that occurs when investor assets are held across multiple brokerage and custodial accounts. The aggregation may provide wealth advisors with a holistic view of investor portfolios for analysis purposes. The tax-deferral recommendation engine 110 may aggregate identical securities across multiple accounts into a single master holding for subsequent analysis while maintaining a pointer to the original account and tax-lot identifier for eventual distribution back to originating accounts.

At step 208, the method 200 performs look-through analysis on pooled investment vehicles held within the linked accounts. The tax-deferral recommendation engine 110 may identify pooled investment vehicles including exchange-traded funds (ETFs), mutual funds, and closed-end funds held within the investor's accounts. For each identified pooled investment vehicle, the tax-deferral recommendation engine 110 may query a data source, such as a third-party API, to retrieve constituent holdings and percentage weights of the pooled investment vehicle. The third-party API may provide data identifying the top constituent holdings and their respective percentage weights within each pooled vehicle. The tax-deferral recommendation engine 110 may calculate the investor's proportionate interest in each underlying security based on the investor's proportionate ownership of the pooled investment vehicle. The look-through analysis may resolve hidden security concentrations that would otherwise require manual decomposition by the wealth advisor. For example, an investor may hold multiple ETFs that each contain overlapping positions in the same underlying security, and the look-through analysis may aggregate the investor's effective exposure to that underlying security across all pooled vehicles.

At step 210, the method 200 retrieves current market data and calculates unrealized capital gains at the tax-lot level. The tax-deferral recommendation engine 110 may receive real-time or end-of-day market prices from a market data feed 122 and calculate the current market value of each position and tax lot. The tax-deferral recommendation engine 110 may calculate the total unrealized short-term and long-term capital gain or loss for each security position at the tax-lot level by subtracting the cost basis from the current market value. The tax-deferral recommendation engine 110 may estimate the tax liability that would result from a taxable sale of each position using applicable short-term and long-term capital gains rates.

At step 212, the method 200 identifies eligible exchange traded funds and estimates the total tax deferral achievable under each available strategy. The tax-deferral recommendation engine 110 may cross-reference the securities held in the investor's portfolio against a database of available tax-deferral opportunities to identify which exchange traded funds accept the securities held in the portfolio. The tax-deferral recommendation engine 110 may estimate the total tax deferral achievable under each available strategy based on the unrealized capital gains calculated at step 210 and the eligibility of portfolio securities for each strategy. The automated cross-referencing may improve accuracy of tax-deferral estimates compared to manual calculations by systematically evaluating each security position against fund eligibility requirements.

At step 214, the method 200 presents ranked tax-deferral recommendations to the wealth advisor. The tax-deferral recommendation engine 110 may generate a ranked dashboard of applicable tax-deferral opportunities based on the linked portfolio characteristics. The ranked recommendations may include estimated tax deferrals for each available strategy, enabling the wealth advisor to compare strategies and select an appropriate approach for the investor.

At step 216, the method 200 receives the wealth advisor's strategy selection. The connection and opportunity platform 108 may receive input from the wealth advisor indicating selection of a tax-deferral strategy from among the ranked recommendations presented at step 214.

At step 218, the method 200 passes the relevant portfolio data to the portfolio optimization and compliance engine 112 for further processing. Upon receiving the strategy selection, the tax-deferral recommendation engine 110 may transmit the aggregated portfolio data, including tax-lot details, market values, and unrealized gain calculations, to the portfolio optimization and compliance engine 112. The portfolio optimization and compliance engine 112 may then execute optimization algorithms to determine securities and quantities to contribute to an exchange fund while enforcing diversification constraints.

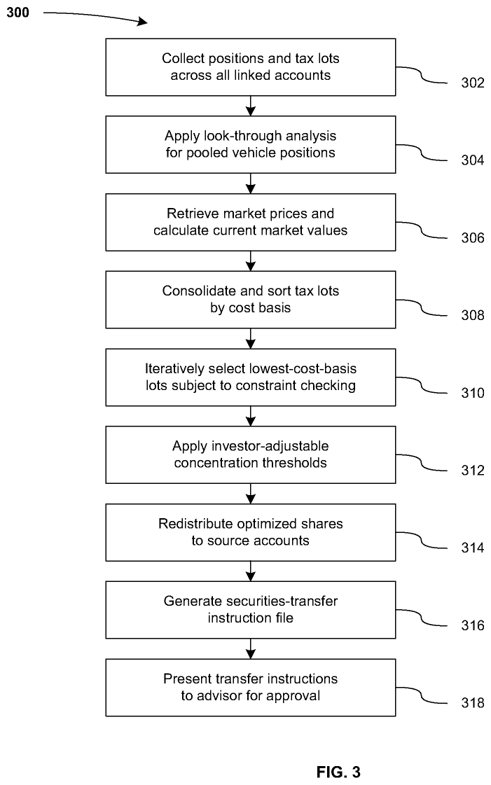

Referring to FIG. 3, in the illustrated embodiment, a method 300 for optimizing a contribution portfolio is performed by the portfolio optimization and compliance engine 112 of the tax-deferred investment platform 106. The method 300 determines a quantity of each security to include in an investor's contribution portfolio to maximize total tax deferral while satisfying applicable diversification constraints.

At step 302, the method 300 collects positions and tax lots across all linked accounts for an individual taxpayer. The portfolio optimization and compliance engine 112 retrieves portfolio data from each linked brokerage and custodial account, including positions, quantities, cost basis, and tax-lot details. In one embodiment, the portfolio optimization and compliance engine 112 receives portfolio data that has been normalized through a preprocessing normalization process. The preprocessing normalization process standardizes heterogeneous data formats from various brokerage platforms into a unified format suitable for optimization processing. Because different custodians employ different data formats, security identifier conventions, and timestamp formats, the preprocessing normalization process synchronizes security identifiers, currency values, and timestamps across all data sources.

At step 304, the method 300 applies look-through analysis for pooled vehicle positions. The portfolio optimization and compliance engine 112 identifies pooled investment vehicles including exchange-traded funds (ETFs), mutual funds, and closed-end funds held within the investor's accounts. For each identified pooled investment vehicle, the portfolio optimization and compliance engine 112 queries a third-party application programming interface (API) to retrieve constituent holdings and percentage weights of the pooled investment vehicle. The portfolio optimization and compliance engine 112 calculates the investor's proportionate interest in each underlying security based on the investor's proportionate ownership of the pooled investment vehicle. The look-through analysis resolves hidden security concentrations that would otherwise require manual decomposition.

With continued reference to FIG. 3, at step 306, the method 300 retrieves market prices and calculates current market values. The portfolio optimization and compliance engine 112 receives real-time, 15-minute delay, or end-of-day market prices from a market data feed 122 and calculates the current market value of each position and tax lot by multiplying the share quantity by the current market price. The portfolio optimization and compliance engine 112 calculates the unrealized capital gain for each tax lot by subtracting the cost basis from the current market value.

At step 308, the method 300 consolidates and sorts tax lots by cost basis from lowest to highest. The portfolio optimization and compliance engine 112 consolidates all tax lots for each security, including tax lots across share classes, from all accounts into a unified view. The consolidated tax lots are sorted in ascending order of cost basis, which corresponds to sorting from highest unrealized gain to lowest unrealized gain. This lowest-basis-first sorting approach maximizes tax deferral by prioritizing the highest-gain lots for contribution to the exchange fund.

In alternative embodiments, the portfolio optimization and compliance engine 112 performs issuer-level aggregation to ensure accurate compliance with diversification constraints across multiple share classes of the same issuer. For companies with multiple equity tranches, such as different voting classes or different ticker symbols representing the same issuer, the portfolio optimization and compliance engine 112 maps each distinct security identifier to a unified parent entity identifier. By consolidating the market values of related securities into a single aggregate exposure for each issuer, the portfolio optimization and compliance engine 112 applies concentration limits to the investor's total economic interest in the issuer rather than to each ticker symbol independently. This issuer-level aggregation prevents the system from treating related share classes as independent securities for diversification testing purposes.

In various embodiments, the portfolio optimization and compliance engine 112 stores tax-lot data using a lot record data structure. Each lot record contains a security identifier (such as a CUSIP number), a share quantity, a cost basis per share, an acquisition date, and a current market price retrieved from the market data feed 122 at solve time. Lots are indexed by a composite key comprising an investor identifier and a lot identifier, enabling efficient retrieval of tax-lot data during optimization processing.

In the illustrated example, the portfolio optimization and compliance engine 112 performs a lot vectorization transform on the tax-lot data. The lot vectorization transform converts each discrete tax lot into a multi-dimensional vector comprising a security identifier, a quantity, a cost basis, a holding period, and an unrealized gain. This transformation enables the portfolio optimization and compliance engine 112 to treat disparate securities as mathematical inputs suitable for rapid optimization processing rather than static database entries.

Referring again to FIG. 3, at step 310, the method 300 iteratively selects lowest-cost-basis tax lots and adds the selected tax lots to a proposed basket subject to constraint checking. The portfolio optimization and compliance engine 112 executes a portfolio optimization algorithm that begins with the lowest-cost-basis tax lot and iteratively adds tax lots to a proposed contribution basket. After each tax lot addition, the portfolio optimization and compliance engine 112 evaluates diversification constraints.

In one embodiment, the diversification constraints include a single-security concentration constraint requiring that a market value of any single security does not exceed a first predetermined threshold of a total portfolio market value. The diversification constraints also include a top-securities concentration constraint requiring that a combined market value of a predetermined number of securities having highest market values does not exceed a second predetermined threshold of the total portfolio market value. In one example, the first predetermined threshold is 25% of the total portfolio market value, the second predetermined threshold is 50% of the total portfolio market value, and the predetermined number of securities is five. These threshold values are example values that an implementer adjusts based on applicable regulatory requirements or fund sponsor specifications.

In alternative embodiments, the diversification constraints include an overweight-position concentration constraint requiring that all positions individually exceeding a third predetermined threshold of the total portfolio market value must in aggregate constitute less than a fourth predetermined threshold of the total portfolio market value. In one example, the third predetermined threshold is 5% and the fourth predetermined threshold is 50%. These threshold values are example values that an implementer adjusts based on applicable requirements.

The portfolio optimization and compliance engine 112 implements a constraint rejection loop that ensures diversification compliance without requiring exhaustive combinatorial search. When a tax lot addition violates a diversification constraint, the portfolio optimization and compliance engine 112 removes the tax lot from the proposed contribution basket and skips to a next lowest-cost-basis tax lot of a different security. The constraint rejection loop continues until the portfolio optimization and compliance engine 112 has evaluated all available tax lots or until the proposed contribution basket satisfies all applicable constraints at a target contribution value.

As further shown in FIG. 3, at step 312, the method 300 applies investor-adjustable concentration thresholds. The portfolio optimization and compliance engine 112 provides a user interface through which an investor or wealth advisor sets custom diversification thresholds below default diversification constraint limits. In one example, an investor specifies a top-one threshold less than 25% and a top-five threshold less than 50%. Upon receiving investor-specified concentration thresholds, the portfolio optimization and compliance engine 112 re-executes the portfolio optimization algorithm subject to the investor-specified thresholds.

At step 314, the method 300 redistributes optimized shares to source accounts while preserving cost-basis tracking. Once the portfolio optimization and compliance engine 112 determines the quantity of shares of each security to include in the contribution portfolio at an aggregate level, the portfolio optimization and compliance engine 112 distributes those shares back to the originating accounts and fund positions from which the shares were sourced. The portfolio optimization and compliance engine 112 prioritizes the lowest-cost-basis tax lots within each security for contribution, thereby maximizing the deferred gain. The portfolio optimization and compliance engine 112 maintains pointers to original account identifiers and tax-lot identifiers throughout the redistribution process to preserve cost-basis tracking.

With continued reference to FIG. 3, at step 316, the method 300 generates a securities-transfer instruction file. The portfolio optimization and compliance engine 112 formats the optimized contribution portfolio into a standardized securities-transfer instruction file addressed to relevant custodians. The securities-transfer instruction file specifies security identifiers, share quantities, source account numbers, and destination fund custodian details. In various embodiments, the securities-transfer instruction file is formatted for transmission via an automated transfer service compatible with major custodians.

At step 318, the method 300 presents transfer instructions to a wealth advisor for review and approval. The portfolio optimization and compliance engine 112 presents the securities-transfer instruction file to the wealth advisor 102 for electronic approval before any transfer is initiated. Upon receiving approval from the wealth advisor 102, the portfolio optimization and compliance engine 112 transmits the securities-transfer instruction file to the relevant custodians to initiate the securities transfer.

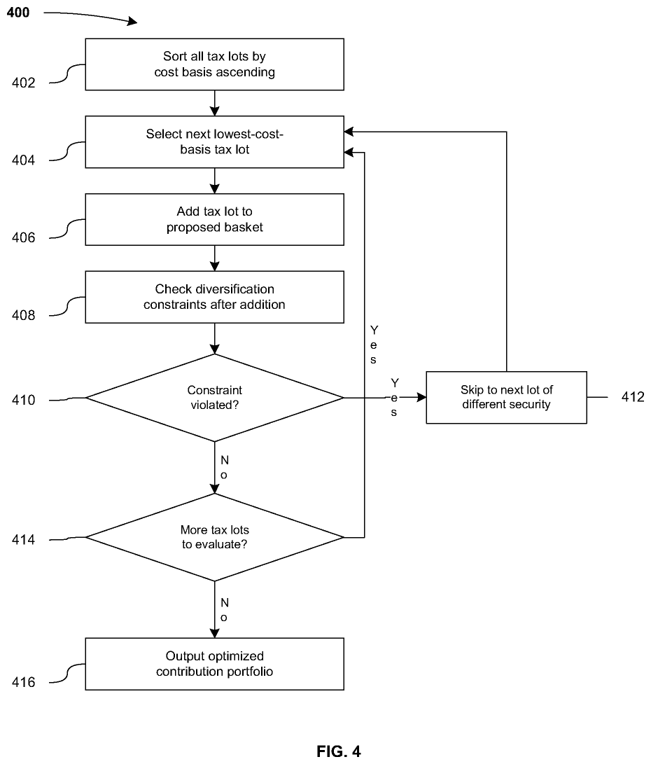

Referring to FIG. 4, in the illustrated embodiment, a method 400 for iterative tax-lot selection and constraint checking is performed by the portfolio optimization and compliance engine 112 of the tax-deferred investment platform 106. The method 400 provides a sequential constraint evaluation approach that reduces computational overhead compared to exhaustive combinatorial search by detecting constraint violations early in the selection process and avoiding unnecessary processing of tax lots that would violate diversification requirements.

At step 402, the method 400 sorts all available tax lots in ascending order of cost basis. The portfolio optimization and compliance engine 112 retrieves tax-lot data from the consolidated view generated during preprocessing and orders the tax lots such that tax lots with the lowest cost basis appear first in the sorted sequence. Because unrealized capital gain equals current market value minus cost basis, sorting by ascending cost basis corresponds to sorting by descending unrealized gain. This ordering ensures that the portfolio optimization and compliance engine 112 evaluates the highest-gain tax lots first, thereby maximizing tax deferral when tax lots are selected for contribution.

At step 404, the method 400 selects the next lowest-cost-basis tax lot from the sorted sequence. The portfolio optimization and compliance engine 112 maintains a pointer to the current position in the sorted tax-lot sequence and retrieves the tax lot at that position. In the first iteration, the portfolio optimization and compliance engine 112 selects the tax lot with the absolute lowest cost basis across all available tax lots.

With continued reference to FIG. 4, at step 406, the method 400 adds the selected tax lot to a proposed contribution basket. The portfolio optimization and compliance engine 112 includes the selected tax lot in a data structure representing the proposed contribution portfolio. The portfolio optimization and compliance engine 112 updates aggregate metrics for the proposed contribution basket, including total market value and per-security market values.

At step 408, the method 400 checks diversification constraints after the addition of the selected tax lot. The portfolio optimization and compliance engine 112 evaluates each applicable diversification constraint against the current state of the proposed contribution basket. By checking constraints immediately after each tax lot addition, the method 400 detects violations early in the selection process and reduces unnecessary processing that would occur if constraint checking were deferred until after all tax lots were selected.

In the illustrated example, the diversification constraints include a single-security concentration constraint, a top-securities concentration constraint, and an overweight-position concentration constraint. The single-security concentration constraint requires that a market value of any single security does not exceed a first predetermined threshold of a total portfolio market value. In one example, the first predetermined threshold is 25% of the total portfolio market value. The top-securities concentration constraint requires that a combined market value of a predetermined number of securities having highest market values does not exceed a second predetermined threshold of the total portfolio market value. In one example, the predetermined number of securities is five and the second predetermined threshold is 50% of the total portfolio market value. The overweight-position concentration constraint requires that all positions individually exceeding a third predetermined threshold of the total portfolio market value must in aggregate constitute less than a fourth predetermined threshold of the total portfolio market value. In one example, the third predetermined threshold is 5% and the fourth predetermined threshold is 50%.

As further shown in FIG. 4, at step 410, the method 400 evaluates whether any diversification constraint is violated by the current state of the proposed contribution basket. The portfolio optimization and compliance engine 112 compares the computed constraint values against the applicable thresholds and determines whether any constraint is in a violated state.

At step 412, responsive to a constraint violation, the method 400 removes the violating tax lot from the proposed contribution basket and skips to a next lowest-cost-basis tax lot of a different security. The portfolio optimization and compliance engine 112 excludes the tax lot that caused the constraint violation from the proposed contribution basket and advances the selection pointer to the next tax lot in the sorted sequence that belongs to a different security than the violating tax lot. By skipping to a different security rather than selecting the next tax lot of the same security, the method 400 avoids repeated constraint failures that would occur when a security has already reached its concentration limit. The method 400 then returns to step 404 to continue the iterative selection process.

At step 414, responsive to no constraint violation, the method 400 evaluates whether more tax lots remain to evaluate in the sorted sequence. The portfolio optimization and compliance engine 112 determines whether the selection pointer has reached the end of the sorted tax-lot sequence or whether the proposed contribution basket has reached a target contribution value.

At step 416, responsive to no more tax lots remaining to evaluate or the target contribution value being reached, the method 400 outputs the optimized contribution portfolio. The portfolio optimization and compliance engine 112 finalizes the proposed contribution basket as the optimized contribution portfolio and transmits the optimized contribution portfolio to subsequent processing stages for redistribution to source accounts and generation of securities-transfer instructions.

In various embodiments, the portfolio optimization and compliance engine 112 linearizes the diversification constraints to enable efficient solver execution. The single-security concentration constraint, expressed as a requirement that a market value of a security does not exceed a percentage of a total portfolio market value, is a self-referential constraint because the total portfolio market value is itself a function of the decision variables representing which tax lots are included in the contribution portfolio. The portfolio optimization and compliance engine 112 rearranges the constraint algebraically such that the total portfolio market value term cancels, transforming the constraint into a linear inequality. For the single-security concentration constraint with a 25% threshold, the constraint that the market value of security s does not exceed 0.25 times the total portfolio market value Vis rearranged to the form:

$${\sum }_{j ∈ L ( s )} {p}_{s} \cdot {x}_{j} - 0.25 \cdot {\sum }_{j} {p}_{s ( j )} \cdot {x}_{j} \leq 0$$

where L(s) is the set of tax lots of security s, pₛ is the market price of security s, xⱼ is a decision variable representing inclusion of tax lot j, and s(j) denotes the security of tax lot j. This rearranged form is linear in the decision variables xⱼ because the self-referential denominator V cancels algebraically. The linearization eliminates the need for general nonlinear solvers and enables the use of linear programming solver technology, which reduces computational cost compared to nonlinear optimization approaches.

In the illustrated example, the top-securities concentration constraint is implemented using auxiliary binary indicator variables. For each security s, the portfolio optimization and compliance engine 112 introduces a binary indicator variable zₛ where zₛ equals one if security s is not among the top five securities by market value. The constraint that the sum of (1-zₛ) across all securities does not exceed five ensures that at most five securities are designated as top securities. The constraint that the sum of market values of securities where (1-zₛ) equals one does not exceed 50% of the total portfolio market value enforces the concentration limit on the top five securities.

In the illustrated example, the overweight-position concentration constraint is implemented using auxiliary binary indicator variables. For each security s, the portfolio optimization and compliance engine 112 introduces a binary indicator variable us where us equals one if the market value of security s exceeds 5% of the total portfolio market value. The constraint that the aggregate market value of all securities where us equals one does not exceed 50% of the total portfolio market value enforces the overweight-position concentration limit.

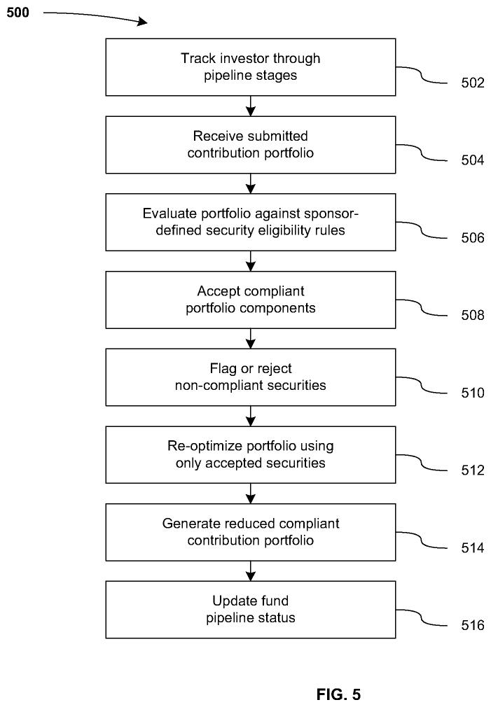

Referring to FIG. 5, in the illustrated embodiment, a method 500 for capital-raising and portfolio acceptance is performed by the capital-raising and portfolio acceptance platform 114 of the tax-deferred investment platform 106. The method 500 enables fund sponsors to manage the fundraising lifecycle for a new investment fund and to automate portfolio acceptance decisions based on sponsor-defined security eligibility rules.

At step 502, the method 500 tracks investors through pipeline stages comprising expression of interest, document execution, portfolio submission, and funded status. The capital-raising and portfolio acceptance platform 114 maintains a pipeline tracking data structure that records the current stage of each investor in the fundraising process. The pipeline tracking provides real-time visibility into investor progress, reducing administrative delays that occur when fund sponsors manually track investor commitments across multiple communication channels. In one embodiment, the capital-raising and portfolio acceptance platform 114 provides a dashboard interface that displays aggregate pipeline metrics including the number of investors at each stage, total committed capital, and estimated completion timelines.

With continued reference to FIG. 5, at step 504, the method 500 receives a submitted contribution portfolio from an investor. The capital-raising and portfolio acceptance platform 114 receives portfolio data comprising security identifiers, share quantities, and cost-basis values for each tax lot in the submitted contribution portfolio. The submitted contribution portfolio represents the securities that the investor proposes to contribute to the new investment fund in exchange for fund shares.

At step 506, the method 500 evaluates the submitted contribution portfolio against sponsor-defined security eligibility rules. The capital-raising and portfolio acceptance platform 114 retrieves a security eligibility rule set defined by the fund sponsor 124, the rule set comprising permitted securities and prohibited securities. The capital-raising and portfolio acceptance platform 114 performs automated rule matching by comparing each security in the submitted contribution portfolio against the permitted securities list and the prohibited securities list. The automated rule matching eliminates manual review bottlenecks that occur when compliance personnel individually evaluate each submitted portfolio against eligibility criteria.

In the illustrated example, at step 508, the method 500 accepts compliant portfolio components. The capital-raising and portfolio acceptance platform 114 identifies securities in the submitted contribution portfolio that appear on the permitted securities list and do not appear on the prohibited securities list. The capital-raising and portfolio acceptance platform 114 marks the identified securities as accepted components of the contribution portfolio.

As further shown in FIG. 5, at step 510, the method 500 flags or rejects non-compliant securities. The capital-raising and portfolio acceptance platform 114 identifies securities in the submitted contribution portfolio that appear on the prohibited securities list or that do not appear on the permitted securities list. The capital-raising and portfolio acceptance platform 114 marks the identified securities as rejected components and generates a notification indicating the rejection reason for each non-compliant security.

At step 512, the method 500 re-optimizes the contribution portfolio using only accepted securities. When the submitted contribution portfolio contains both accepted and rejected securities, the capital-raising and portfolio acceptance platform 114 invokes the portfolio optimization and compliance engine 112 to generate a new optimized contribution portfolio using only the accepted securities. The portfolio optimization and compliance engine 112 executes the portfolio optimization algorithm described with reference to FIG. 3 and FIG. 4, applying diversification constraints to the reduced set of accepted securities.

With continued reference to FIG. 5, at step 514, the method 500 generates a reduced but compliant contribution portfolio. The capital-raising and portfolio acceptance platform 114 receives the re-optimized contribution portfolio from the portfolio optimization and compliance engine 112. The reduced contribution portfolio satisfies both the sponsor-defined security eligibility rules and the applicable diversification constraints. The re-optimization preserves maximum tax deferral within compliance boundaries by selecting the lowest-cost-basis tax lots from among the accepted securities.

In alternative embodiments, the portfolio optimization and compliance engine 112 re-evaluates the contribution portfolio in response to updated market prices prior to exchange execution. Because the relative market weights and diversification compliance of the accepted securities are subject to price changes, the portfolio optimization and compliance engine 112 retrieves updated market prices from the market data feed 122 and recalculates market values for each security in the contribution portfolio. When the updated market values cause a diversification constraint to be violated, the portfolio optimization and compliance engine 112 re-executes the portfolio optimization algorithm to generate a revised contribution portfolio that satisfies all applicable constraints at the updated market prices. This re-optimization ensures that the contribution portfolio remains compliant with sponsor-defined security eligibility rules and diversification constraints at prevailing market prices.

At step 516, the method 500 updates the fund pipeline status. The capital-raising and portfolio acceptance platform 114 updates the investor's pipeline stage to reflect the portfolio submission and acceptance status. In one embodiment, the capital-raising and portfolio acceptance platform 114 advances the investor to a portfolio-accepted stage upon successful acceptance of the contribution portfolio. The capital-raising and portfolio acceptance platform 114 transmits a notification to the fund sponsor 124 indicating the updated pipeline status.

In various embodiments, the capital-raising and portfolio acceptance platform 114 provides communication tools that connect fund sponsors with wealth advisors and investors. The communication tools enable fund sponsors to transmit status updates, document requests, and acceptance notifications to wealth advisors and investors through the tax-deferred investment platform 106. The communication tools provide a centralized channel for fundraising communications, reducing fragmentation that occurs when communications are distributed across multiple email threads and messaging systems.

In the illustrated example, the capital-raising and portfolio acceptance platform 114 provides document collection and management functionality for legal and regulatory requirements. The capital-raising and portfolio acceptance platform 114 maintains a document repository that stores executed legal documents, investor certifications, and regulatory filings associated with each investor in the fundraising pipeline. The document collection functionality tracks document completion status for each investor and generates reminders for outstanding document requirements.

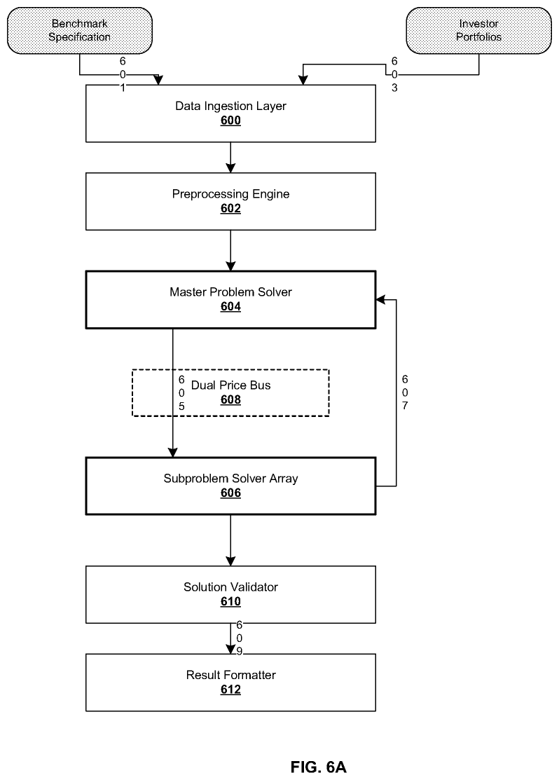

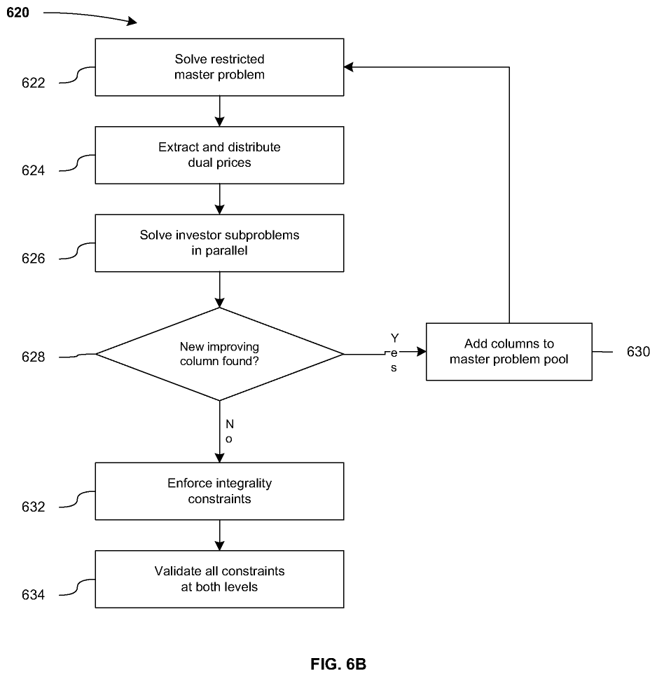

Referring to FIG. 6A, in the illustrated embodiment, a completion portfolio matchmaking engine 116 of the tax-deferred investment platform 106 assembles a completion portfolio for a new investment fund from securities held across a plurality of investor portfolios. The completion portfolio matchmaking engine 116 employs a column-generation decomposition architecture that converts a monolithic optimization problem into a sequence of tractable smaller problems. The monolithic optimization problem is NP-hard due to the presence of binary indicator variables in the constraint set and the non-convex feasible region arising from concentration constraints that subsume ranking problems. The column-generation decomposition exploits block-angular structure in the constraint matrix, where investor-level constraints are independent across investors and coupled only through fund-level constraints.

A data ingestion layer 600 receives investor portfolio records via an investor portfolio data flow 603 and a fund sponsor's target benchmark specification via a benchmark specification data flow 601. The investor portfolio data flow 603 transmits portfolio data comprising security identifiers, share quantities, cost-basis values, acquisition dates, and current market prices for each tax lot held by each investor. The benchmark specification data flow 601 transmits a target portfolio specification comprising target securities, target weightings, permitted securities, and prohibited securities defined by the fund sponsor 124.

With continued reference to FIG. 6A, a preprocessing engine 602 receives data from the data ingestion layer 600 and normalizes inputs, computes per-lot gain metrics, and constructs an initial constraint state. The preprocessing engine 602 normalizes security identifiers, currency values, and timestamps across data sources from disparate brokerage platforms into a unified format suitable for optimization processing. The preprocessing engine 602 computes lot-level metrics including unrealized gain, market value, and gain ratio for each tax lot. The preprocessing engine 602 constructs constraint state vectors that track the initial state of diversification constraints at both investor and fund levels.

In the illustrated example, the preprocessing engine 602 performs dominance pruning by identifying, for each investor, dominated tax lots. A first lot of a security is dominated by a second lot of the same security when the second lot has a lower cost basis and a higher share count than the first lot. The preprocessing engine 602 excludes dominated tax lots from subsequent subproblem processing because dominated lots cannot appear in an optimal solution. Dominance pruning reduces the dimension of each investor subproblem.

A master problem solver 604 maintains fund-level tracking error and fund-level diversification constraints. The master problem solver 604 maintains a pool of candidate contribution portfolios, referred to as columns, for each investor. Each column represents a specific, investor-constraint-feasible assignment of lot quantities. The master problem solver 604 selects a convex combination of columns for each investor to minimize tracking error subject to fund-level constraints. The master problem solver 604 defines a weight variable for each investor and each candidate contribution portfolio, where the weight variable represents the fraction of the candidate portfolio included in the final solution. A convexity constraint ensures that exactly one contribution portfolio or a convex combination thereof is selected per investor.

As further shown in FIG. 6A, the master problem solver 604 combines two objectives into a single scalar function. A tracking error component measures the squared deviation between the assembled completion portfolio's per-security weights and the target benchmark weights. A tax deferral component measures the total unrealized gain contributed across all investors. The master problem solver 604 minimizes a weighted combination of tracking error and normalized tax deferral, where a trade-off parameter controls the relative importance of benchmark adherence versus tax deferral. Dividing the tax deferral component by the total portfolio market value normalizes the deferral term to the same scale as tracking error, preventing dimensional mismatch from distorting the trade-off.

The master problem solver 604 transmits dual price signals 605 through a dual price bus 608 to a subproblem solver array 606. The dual price signals 605 comprise a dual variable vector associated with fund-level benchmark-tracking constraints, with one dual price per security, and dual variables associated with fund-level concentration constraints. The dual prices encode the marginal fund-level cost of each security, representing the marginal impact of adding one dollar of that security on tracking error and fund-level constraint slack. The dual price bus 608 transmits dual variable vectors from the master problem solver 604 to the subproblem solver array 606 and returns candidate contribution columns from the subproblem solver array 606 to the master problem solver 604.

With continued reference to FIG. 6A, the subproblem solver array 606 contains parallel solver instances, one per candidate investor. Each subproblem solver in the subproblem solver array 606 runs as an independent process receiving the dual price vector as input and returning a candidate column as output. Because subproblems are fully independent given dual prices, parallelism is embarrassingly parallel with no inter-process communication required during a subproblem solve. The master problem solver 604 executes on a single thread because the master problem is a moderate-size quadratic program that solves in milliseconds.

Each subproblem solver in the subproblem solver array 606 solves an investor subproblem that generates a candidate contribution portfolio for the assigned investor. Each investor subproblem maximizes a tax-deferral objective modified by the dual prices such that securities overrepresented at a fund level are penalized and securities underrepresented at the fund level are favored. The subtracted dual-price terms modify the tax-deferral objective so that contributing securities that are overrepresented at the fund level, which carry high dual prices, becomes less attractive, and contributing securities the fund needs, which carry low or negative dual prices, becomes more attractive. This modification causes each investor's subproblem to internalize the fund-level impact of the investor's contribution without requiring direct knowledge of any other investor's holdings.

In the illustrated example, each subproblem solver warm-starts with a solution from a previous column-generation iteration. Because dual prices change incrementally between iterations, the warm-started solution is typically near-optimal, reducing per-iteration subproblem solve time. The subproblem solver array 606 returns candidate columns to the master problem solver 604 via a candidate column data flow 607. Each subproblem solver computes a reduced cost for the resulting candidate column and returns the candidate contribution portfolio to the master problem solver 604 responsive to the reduced cost exceeding the convergence threshold. When the reduced cost does not exceed the convergence threshold, the subproblem solver returns null, indicating no improving column for that investor.

The subproblem solver array 606 provides a technical advantage over direct monolithic solution. The subproblems are independent mixed-integer quadratic programs of manageable size, with each subproblem having a number of variables corresponding to the number of lots held by the assigned investor, versus the sum of all lots across all investors for the monolithic problem. Each subproblem is solvable in seconds even for investors holding more than 200 lots. The decomposition converts one intractable mixed-integer quadratic program into a sequence of tractable smaller problems, enabling polynomial-time per-iteration cost.

As further shown in FIG. 6A, a solution validator 610 performs final constraint verification at both investor and fund levels. The solution validator 610 receives the converged solution from the master problem solver 604 and verifies that all investor-level and fund-level diversification constraints are satisfied. A result formatter 612 outputs per-investor contribution schedules, the assembled completion portfolio, and diagnostic metrics via a validated solution data flow 609. The diagnostic metrics include tracking error relative to the benchmark, per-investor unrealized gain contributed and tax deferred, aggregate tax deferral, and per-constraint slack for all investor-level and fund-level constraints.

In various embodiments, the completion portfolio matchmaking engine 116 stores the sponsor's target benchmark as a sparse benchmark vector mapping security identifiers to target weights. Only securities with nonzero target weight are stored in the sparse benchmark vector, providing memory-efficient storage for benchmarks that contain a subset of all available securities.

In the illustrated example, the completion portfolio matchmaking engine 116 maintains a constraint margin vector that tracks, for each active constraint at both investor and fund levels, a current slack representing a distance from a constraint limit. The constraint margin vector is keyed by a tuple comprising constraint type, entity identifier, and security identifier, and stores current utilization, limit, and residual slack. The constraint margin vector is incrementally updated as columns are added to or removed from the master problem, avoiding full recomputation of all constraint values at each iteration. The incremental update provides constant-time constraint slack evaluation during iterative column generation.

In the illustrated example, each candidate contribution portfolio is stored as a sparse vector of lot identifier and share quantity pairs, along with precomputed metadata comprising per-security market value contribution, total market value, total unrealized gain, and investor-level constraint satisfaction flags. Precomputation avoids redundant recalculation during master problem solves.

Referring to FIG. 6B, in the illustrated embodiment, a method 620 for a column generation iteration cycle is performed by the completion portfolio matchmaking engine 116 of the tax-deferred investment platform 106. The method 620 provides an iterative convergence process that coordinates investor-level subproblems through dual prices to assemble a completion portfolio that satisfies fund-level constraints while maximizing tax deferral across participating investors.

In the illustrated example, prior to entering the column generation iteration cycle, the completion portfolio matchmaking engine 116 initializes a column pool with greedy seed columns for each investor. For each investor, the completion portfolio matchmaking engine 116 sorts tax lots by cost basis in ascending order, where lowest cost basis corresponds to highest tax deferral. The completion portfolio matchmaking engine 116 greedily adds tax lots to a candidate contribution, stopping when any investor-level constraint would be violated. The greedy seed column for each investor is stored as an initial column in the column pool. The greedy seed columns ensure that the master problem is feasible from the first iteration, enabling the master problem solver 604 to produce meaningful dual prices. Without a feasible initial column set, the master problem solver 604 cannot generate dual prices that guide subproblem optimization.

With continued reference to FIG. 6B, the method 620 executes an outer loop over a set of trade-off parameter values. In the illustrated example, the trade-off parameter a spans values from 0.1 to 0.9 at configurable resolution, with a default of nine solutions at 0.1 increments. Each value of a produces a distinct solution that balances benchmark adherence against tax deferral. When a is set high, benchmark adherence is prioritized. When a is set low, tax deferral is prioritized. The completion portfolio matchmaking engine 116 produces alpha-parameterized solutions that enable fund sponsors to evaluate trade-offs between tracking error and aggregate tax deferral.

At step 622, the method 620 solves a restricted master problem to compute optimal column weights and dual prices. The master problem solver 604 constructs a quadratic program with decision variables λᵢₖ≥0 for each investor i and each candidate contribution portfolio k in the column pool. The variable λᵢₖ represents the fraction of candidate portfolio k included in the final solution. A convexity constraint ensures that exactly one contribution portfolio or a convex combination thereof is selected per investor by requiring that the sum of λᵢₖ across all columns k for each investor i equals one.

In the illustrated example, the master problem solver 604 minimizes a weighted combination of tracking error and normalized tax deferral. The tracking error component is calculated as:

$$TE = {\sum }_{s} {( \frac{{h}_{s}}{V} - {w}_{s}^{T} )}^{2}$$

where hₛ is the total market value of security s in the completion portfolio, V is the total market value of the assembled completion portfolio, and wₛ^{T} is the target benchmark weight for security s. The squared tracking error calculation measures the squared deviation between the assembled completion portfolio's per-security weights and the target benchmark weights. The master problem objective minimizes α·TE−(1−α)·(TD/V), where TD is the aggregate tax deferral and dividing TD by V normalizes the deferral term to the same scale as tracking error.

As further shown in FIG. 6B, the master problem solver 604 enforces fund-level diversification constraints. In the illustrated example, the fund-level constraints include a single-security concentration constraint requiring that a market value of any single security does not exceed 25% of the total fund portfolio market value, and a top-securities concentration constraint requiring that a combined market value of five securities having highest market values does not exceed 50% of the total fund portfolio market value. The top-securities concentration constraint is implemented using auxiliary binary indicator variables zₛ for each security s, where zₛ equals one if security s is not among the top five securities by market value. A constraint that the sum of (1-zₛ) across all securities does not exceed five ensures that at most five securities are designated as top securities.

At step 624, the method 620 extracts dual prices from the master problem and distributes the dual prices to all subproblem solvers. The master problem solver 604 extracts a dual variable vector Is associated with fund-level benchmark-tracking constraints, with one dual price per security s, and dual variables u associated with fund-level concentration constraints. The dual prices encode the marginal fund-level cost of each security, representing the marginal impact of adding one dollar of that security on tracking error and fund-level constraint slack. The dual price bus 608 transmits the dual variable vectors from the master problem solver 604 to the subproblem solver array 606. The dual price distribution enables decentralized coordination without global state sharing, as each subproblem solver receives only the dual price vector as input and does not require direct knowledge of any other investor's holdings.

With continued reference to FIG. 6B, at step 626, the method 620 solves investor subproblems in parallel. Each subproblem solver in the subproblem solver array 606 generates a candidate contribution portfolio for the assigned investor. Each investor subproblem maximizes a tax-deferral objective modified by the dual prices such that securities overrepresented at a fund level are penalized and securities underrepresented at the fund level are favored. The subtracted dual-price terms modify the tax-deferral objective so that contributing securities that carry high dual prices becomes less attractive, and contributing securities the fund needs, which carry low or negative dual prices, becomes more attractive.

In the illustrated example, each subproblem solver warm-starts with a solution from a previous column-generation iteration. Because dual prices change incrementally between iterations, the warm-started solution is typically near-optimal, reducing per-iteration subproblem solve time. The warm-start optimization retains prior solutions to accelerate convergence. Each subproblem solver returns a candidate column to the master problem solver 604 via the candidate column data flow 607.

At step 628, the method 620 performs a convergence check by evaluating whether any candidate contribution portfolio has a reduced cost exceeding a convergence threshold. In the illustrated example, the convergence threshold ε has a default value of 10⁻⁴. The method 620 applies multi-criteria termination conditions. The column generation loop terminates when all of the following hold: no subproblem produces a column with reduced cost exceeding ε; the relative improvement in the master objective between consecutive iterations is below a threshold δ, with a default value of 10⁻⁶; or the iteration count exceeds a configurable maximum Tₘₐₓ, with a default value of 500. The completion portfolio matchmaking engine 116 reports which criterion triggered termination. If termination occurs by iteration limit, the output includes an optimality gap calculated as the difference between the best bound and the current objective divided by the current objective.

As further shown in FIG. 6B, at step 630, responsive to a candidate contribution portfolio having a reduced cost exceeding the convergence threshold, the method 620 adds the improving candidate contribution portfolio to the column pool of the master problem. The master problem solver 604 limits the active column pool to at most K columns per investor, where K is configurable with a default value of 20. When the column pool exceeds K columns for an investor, the master problem solver 604 applies an eviction policy that removes columns with zero or near-zero weight in the current master solution. In the illustrated example, columns with λᵢₖ less than 10⁻⁸ in the current master solution are evicted. The eviction policy bounds the master problem size at O(N·K) columns regardless of the number of iterations, where N is the number of investors. After adding improving columns and applying the eviction policy, the method 620 returns to step 622 to repeat solving the master problem.

In the illustrated example, when the master problem cannot satisfy fund-level constraints with the available columns after column generation converges, the completion portfolio matchmaking engine 116 enters an incremental constraint relaxation protocol. The incremental constraint relaxation protocol relaxes the tracking-error tolerance in steps of 0.5% until a feasible solution is found. The completion portfolio matchmaking engine 116 reports the relaxed tolerance in the output.

At step 632, responsive to no candidate contribution portfolio having a reduced cost exceeding the convergence threshold, the method 620 enforces integrality constraints. The current master solution assigns fractional λ weights to columns. The completion portfolio matchmaking engine 116 rounds the continuous column weights by selecting, for each investor, the column k with the highest λᵢₖ value. The completion portfolio matchmaking engine 116 rechecks all fund-level constraints with the rounded solution. If any fund-level constraint is violated after rounding, the completion portfolio matchmaking engine 116 performs local repair by identifying the security causing the violation and reducing the contribution of that security from the investor whose lot has the highest cost basis. The local repair preserves deferral quality by sacrificing the least valuable deferral first. The completion portfolio matchmaking engine 116 updates the constraint margin vector with final values after integrality enforcement.

With continued reference to FIG. 6B, at step 634, the method 620 performs final constraint validation at both investor and fund levels. The solution validator 610 verifies that all investor-level diversification constraints are satisfied for each investor. The solution validator 610 verifies that all fund-level diversification constraints are satisfied. The solution validator 610 computes tracking error relative to the benchmark, per-investor unrealized gain contributed and tax deferred, aggregate tax deferral, and per-constraint slack values for all investor-level and fund-level constraints. The result formatter 612 stores the solution record for the current a value.

In the illustrated example, after completing the outer loop over all a values, the completion portfolio matchmaking engine 116 ranks solutions by a lexicographic key comprising constraint feasibility and tracking error. The result formatter 612 outputs per-investor contribution schedules, the assembled completion portfolio, and diagnostic metrics via the validated solution data flow 609.

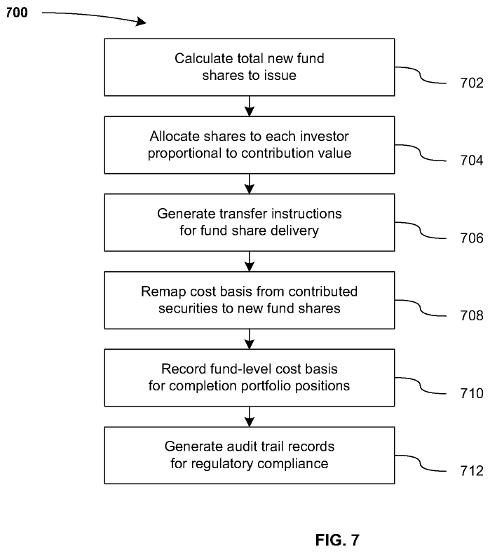

Referring to FIG. 7, in the illustrated embodiment, a method 700 for fund formation and share issuance is performed by the fund formation and share-issuance module 118 of the tax-deferred investment platform 106. The method 700 automates the legal and operational steps required to issue shares in a new investment fund and complete a tax-deferred securities exchange. The fund formation and share-issuance module 118 receives a completion portfolio comprising securities contributed by a plurality of investors, each investor having contributed securities with associated tax-lot cost-basis records.

At step 702, the method 700 calculates a total number of new fund shares to issue. The fund formation and share-issuance module 118 computes the total number of new fund shares using the following formula:

$$Shares ∖ \_Issued = \frac{Total Market Value of Contributed Securities}{NAV per Share of New Fund}$$

The fund formation and share-issuance module 118 retrieves current market prices for each contributed security from the market data feed 122. The fund formation and share-issuance module 118 computes a market value for each contributed security by multiplying a share quantity by the current market price. The fund formation and share-issuance module 118 sums market values across all contributed securities to obtain the aggregate market value. The fund formation and share-issuance module 118 divides the aggregate market value by a target net asset value (NAV) per share specified by the fund sponsor 124 to determine the total number of new fund shares to issue. This calculation ensures proportional allocation accuracy by establishing a consistent share price basis for all contributing investors.

With continued reference to FIG. 7, at step 704, the method 700 allocates new fund shares to each investor proportionally. The fund formation and share-issuance module 118 allocates new fund shares to each investor in proportion to a market value of that investor's contributed securities relative to the aggregate market value. For each investor, the fund formation and share-issuance module 118 calculates the investor's share allocation by multiplying the total number of new fund shares by the ratio of the investor's contribution market value to the aggregate market value. The proportional allocation ensures that each investor receives fund shares commensurate with the value of securities contributed by that investor.

At step 706, the method 700 generates transfer instructions for fund share delivery. The fund formation and share-issuance module 118 generates securities-transfer instructions directing delivery of allocated new fund shares to each investor's designated brokerage or custodial account. In the illustrated example, the fund formation and share-issuance module 118 formats transfer data according to requirements of a destination custodian account. The fund formation and share-issuance module 118 generates transfer instructions formatted for transmission, e.g., via Automated Customer Account Transfer Service (ACATS) or Non-ACATS protocols compatible with major custodians. The fund formation and share-issuance module 118 generates transfer instructions formatted for transmission via standardized electronic book-entry protocols, including, for example, Automated Customer Account Transfer Service (ACATS), Fast Automated Securities Transfer (FAST), Direct Registration System (DRS), or Deposit & Withdrawal at Custodian (DWAC) protocols compatible with the Depository Trust Company (DTC) and other major custodians. The standardized formatting reduces manual formatting errors that occur when transfer instructions are prepared manually for different custodian systems. The fund formation and share-issuance module 118 transmits the securities-transfer instructions to the custodian 126 to initiate delivery of new fund shares.

As further shown in FIG. 7, at step 708, the method 700 remaps cost basis from contributed securities to newly issued fund shares. The fund formation and share-issuance module 118 assigns, to each investor's allocated fund shares, a cost basis corresponding to an original cost basis of securities contributed by that investor. The fund formation and share-issuance module 118 creates a database record where the cost basis of the contributed securities is assigned as the cost basis of the received fund shares. Specifically, the module 118 identifies the total aggregate cost basis of the specific tax lot that was exchanged and calculates a new per-share cost basis by dividing that total cost by the initial share price of the newly issued fund shares. The original acquisition date of the contributed securities is preserved and associated with the new fund shares to maintain tax-lot continuity, and this remapped cost-basis and acquisition data is subsequently relayed to the investor's designated brokerage account. The cost-basis remapping preserves a deferred gain in the new fund shares by maintaining tax-lot continuity between the contributed securities and the newly issued fund shares. The fund formation and share-issuance module 118 maintains pointers linking each investor's allocated fund shares to the original contributing tax lots, associated cost-basis information, and transfer-instruction details.

At step 710, the method 700 records fund-level cost basis for completion portfolio positions. The fund formation and share-issuance module 118 records cost-basis information at a fund level for each contributed security to establish the fund's initial tax basis in completion portfolio positions. The fund-level cost-basis records enable the fund to track the tax basis of each security position in the completion portfolio for subsequent fund-level tax reporting and gain/loss calculations.

With continued reference to FIG. 7, at step 712, the method 700 generates audit trail records for regulatory compliance. The fund formation and share-issuance module 118 generates timestamped audit trail records comprising transaction records, allocation records, cost-basis assignments, and transfer instructions. The audit trail records provide a comprehensive record of all transactions and allocations for regulatory compliance and audit purposes. In the illustrated example, the fund formation and share-issuance module 118 generates a per-investor record comprising allocated fund shares, original contributing tax lots, associated cost-basis information, and transfer-instruction details. In some embodiments, the system generates comparative scenario reports that demonstrate the value of the tax deferral achieved through the exchange. The comparative scenario reports may include an alternate scenario representing the tax liability that would have resulted from a taxable sale of the contributed securities and an optimized scenario representing the tax deferral achieved through the tax-deferred exchange. In various embodiments, the alternate scenario calculates estimated taxes based on applicable short-term and long-term capital gains rates applied to the unrealized gains of the contributed securities. The optimized scenario displays the deferred tax liability preserved through the exchange. The comparative scenario reports can be generated for each optimization run and stored as part of the audit trail for compliance and auditing purposes.

In various embodiments, the fund formation and share-issuance module 118 performs control group validation prior to completing the exchange. The fund formation and share-issuance module 118 validates that a control group of contributing investors collectively owns at least 80% of the voting stock of the new fund immediately after the exchange. This threshold value is an example value that an implementer adjusts based on applicable regulatory requirements or fund sponsor specifications. The 80% control validation ensures that the exchange satisfies applicable regulatory requirements for tax-deferred treatment. When the control group ownership percentage falls below the 80% threshold, the fund formation and share-issuance module 118 generates a notification indicating that the exchange does not satisfy the control group requirement.

In the illustrated example, the fund formation and share-issuance module 118 implements security measures to safeguard sensitive financial data throughout the fund formation process. The fund formation and share-issuance module 118 implements administrative, technical, and physical safeguards to protect customer information in compliance with the Gramm-Leach-Bliley Act (GLBA). The GLBA compliance measures include encryption of data both in transit and at rest, access controls such as role-based permissions, and secure authentication protocols. The fund formation and share-issuance module 118 maintains records of data access, modifications, and system activities to facilitate regulatory oversight and internal audits.

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the element or component is present unless it is obvious that it is meant otherwise.

Where values are described as “approximate” or “substantially” (or their derivatives), such values should be construed as accurate+/−10% unless another meaning is apparent from the context. From example, “approximately ten” should be understood to mean “in a range from nine to eleven.”

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for providing end-to-end registry, custody, issuance, trading, settlement, and servicing of digital assets and tokenized assets. Thus, while particular embodiments and applications have been illustrated and described, it is to be understood that the described subject matter is not limited to the precise construction and components disclosed. The scope of protection should be limited only by any claims that may ultimately issue.

1. A computer-implemented method for optimizing a contribution portfolio for a tax-deferred securities exchange, the method comprising:
receiving, by one or more processors, portfolio data for an investor from a plurality of financial accounts, the portfolio data comprising positions, quantities, and tax-lot cost-basis records;
performing, by the one or more processors, look-through analysis on pooled investment vehicles held within the plurality of financial accounts by querying a data source to retrieve constituent holdings and percentage weights of each pooled investment vehicle, and calculating the investor's proportionate interest in each underlying security based on the investor's proportionate ownership of the pooled investment vehicle;
aggregating, by the one or more processors, tax lots for each security across all financial accounts and pooled vehicles into a consolidated view sorted by cost basis from lowest to highest;
executing, by the one or more processors, a portfolio optimization algorithm that iteratively selects tax lots in ascending order of cost basis and adds each selected tax lot to a proposed contribution basket, wherein after each addition the algorithm evaluates diversification constraints comprising:
a single-security concentration constraint requiring that a market value of any single security does not exceed a first predetermined threshold of a total portfolio market value; and
a top-securities concentration constraint requiring that a combined market value of a predetermined number of securities having highest market values does not exceed a second predetermined threshold of the total portfolio market value;
wherein responsive to a tax lot addition violating a diversification constraint, the algorithm removes the tax lot from the proposed contribution basket and proceeds to a next lowest-cost-basis tax lot of a different security;
redistributing, by the one or more processors, optimized share quantities to originating accounts by assigning shares to tax lots in order of lowest cost basis first; and
generating, by the one or more processors, a securities-transfer instruction file specifying the optimized contribution portfolio for transmission to a financial custodian.

2. The method of claim 1, wherein executing the portfolio optimization algorithm further comprises applying an overweight-position concentration constraint requiring that an aggregate market value of all positions that individually exceed a third predetermined threshold of the total portfolio market value must constitute less than a fourth predetermined threshold of the total portfolio market value.

3. The method of claim 1, wherein the first predetermined threshold is 25% of the total portfolio market value, the second predetermined threshold is 50% of the total portfolio market value, and the predetermined number of securities is five.

4. The method of claim 1, further comprising:
receiving, via a user interface, investor-specified concentration thresholds below default diversification constraint limits; and
re-executing the portfolio optimization algorithm subject to the investor-specified concentration thresholds.

5. The method of claim 1, further comprising:
querying current market price data sources to retrieve current market prices for each security;
calculating, for each tax lot, an unrealized capital gain by subtracting the cost basis from a current market value;
estimating a tax liability that would result from a taxable sale of each position using applicable capital gains rates; and
presenting the securities-transfer instruction file to a wealth advisor for electronic approval prior to transmitting the instruction file to the financial custodian.

6. The method of claim 1, further comprising:
evaluating the optimized contribution portfolio against sponsor-defined security eligibility rules comprising permitted securities and prohibited securities;
accepting portfolio components comprising permitted securities;
flagging portfolio components comprising prohibited securities; and
re-optimizing the contribution portfolio using only the accepted securities to generate a reduced but compliant contribution portfolio.

7. The method of claim 1, wherein the securities-transfer instruction file comprises security identifiers, share quantities, source account numbers, and destination custodian details formatted for transmission via an automated transfer service.

8. The method of claim 1, further comprising:
performing issuer-level aggregation by mapping distinct security identifiers representing multiple share classes of a same issuer to a unified parent entity identifier;
applying the diversification constraints to an aggregate market value of all securities mapped to each unified parent entity identifier;
re-evaluating the optimized contribution portfolio in response to updated market prices prior to exchange execution;
recalculating market values for each security in the contribution portfolio based on the updated market prices; and
responsive to the updated market values causing a diversification constraint to be violated, re-executing the portfolio optimization algorithm to generate a revised contribution portfolio.

9. A system for assembling a completion portfolio for a new investment fund from securities held across a plurality of investor portfolios, the system comprising:
one or more processors; and
a non-transitory computer-readable medium storing instructions that, when executed by the one or more processors, cause the system to:
receive a target portfolio specification from a fund sponsor, the target portfolio specification comprising target securities, target weightings, permitted securities, and prohibited securities;
receive investor portfolio data from a plurality of investors, each investor portfolio comprising tax lots with security identifiers, share quantities, and cost-basis values;
solve a master problem that tracks fund-level benchmark adherence and fund-level diversification constraints, wherein solving the master problem comprises computing optimal column weights and extracting dual prices for each security;
transmit the dual prices to a plurality of subproblem solvers, wherein each subproblem solver is assigned to a respective investor;
solve, by each subproblem solver in parallel, an investor subproblem that generates a candidate contribution portfolio for the assigned investor, wherein each investor subproblem maximizes a tax-deferral objective modified by the dual prices such that securities overrepresented at a fund level are penalized and securities underrepresented at the fund level are favored;
evaluate whether any candidate contribution portfolio has a reduced cost exceeding a convergence threshold;
responsive to a candidate contribution portfolio having a reduced cost exceeding the convergence threshold, add the candidate contribution portfolio to a column pool of the master problem and repeat solving the master problem;
responsive to no candidate contribution portfolio having a reduced cost exceeding the convergence threshold, enforce integrality constraints by selecting contribution portfolios for each investor; and
output per-investor contribution schedules and an assembled completion portfolio.

10. The system of claim 9, wherein the instructions further cause the system to:
apply fund-level diversification constraints comprising a requirement that a market value of any single security does not exceed a first predetermined threshold of a total fund portfolio market value and a requirement that a combined market value of a predetermined number of securities having highest market values does not exceed a second predetermined threshold of the total fund portfolio market value; and
apply investor-level diversification constraints comprising the same concentration requirements applied independently to each investor's contribution portfolio.

11. The system of claim 9, wherein the instructions further cause the system to:
linearize self-referential percentage-based diversification constraints by algebraic rearrangement, wherein a constraint that a market value of a security does not exceed a percentage of a total portfolio market value is rearranged into a linear inequality in which a total portfolio market value term cancels algebraically.

12. The system of claim 9, wherein the instructions further cause the system to:
compute a strategy alignment score expressing a percentage similarity between the assembled completion portfolio and a sponsor-defined benchmark portfolio by comparing security weightings of the assembled completion portfolio against weightings of the benchmark portfolio; and
responsive to termination by an iteration limit, output an optimality gap calculated as a difference between a best bound and a current objective divided by the current objective.

13. The system of claim 9, wherein the instructions further cause the system to:
perform dominance pruning by identifying, for each investor, dominated tax lots wherein a first lot of a security has a lower cost basis and a higher share count than a second lot of the same security such that the second lot is a dominated tax lot, and excluding the dominated tax lots from the investor subproblem.

14. The system of claim 9, wherein the instructions further cause the system to:
maintain a constraint margin vector that tracks, for each active constraint at both investor and fund levels, a current slack representing a distance from a constraint limit, wherein the constraint margin vector is incrementally updated as columns are added to or removed from the master problem;
wherein solving each investor subproblem comprises warm-starting with a solution from a previous iteration and returning a candidate contribution portfolio responsive to a reduced cost exceeding the convergence threshold.

15. The system of claim 9, wherein the instructions further cause the system to:
produce a plurality of solutions across a range of trade-off parameter values, wherein each trade-off parameter value controls a relative importance of benchmark adherence versus tax deferral; and
rank the plurality of solutions to enable evaluation of trade-offs between tracking error and aggregate tax deferral.

16. A system for automating investment fund formation in connection with a tax-deferred securities exchange, the system comprising:
one or more processors; and
a non-transitory computer-readable medium storing instructions that, when executed by the one or more processors, cause the system to:
receive a completion portfolio comprising securities contributed by a plurality of investors, each investor having contributed securities with associated tax-lot cost-basis records;
calculate a total number of new fund shares to issue by dividing an aggregate market value of all contributed securities by a target net asset value per share;
allocate new fund shares to each investor in proportion to a market value of that investor's contributed securities relative to the aggregate market value;
generate securities-transfer instructions directing delivery of allocated new fund shares to each investor's designated account;
remap cost basis from contributed securities to newly issued fund shares by assigning, to each investor's allocated fund shares, a cost basis corresponding to an original cost basis of securities contributed by that investor, thereby preserving a deferred gain in the new fund shares; and
record, at a fund level, cost-basis information for each contributed security to establish the fund's initial tax basis in completion portfolio positions.

17. The system of claim 16, wherein the instructions further cause the system to:
generate an audit trail record comprising transaction records, allocation records, cost-basis assignments, and transfer instructions for regulatory compliance purposes; and
generate a comparative scenario report comprising an alternate scenario representing a tax liability that would have resulted from a taxable sale of the contributed securities and an optimized scenario representing a tax deferral achieved through the tax-deferred exchange.

18. The system of claim 16, wherein the instructions further cause the system to:
generate a per-investor record comprising allocated fund shares, original contributing tax lots, associated cost-basis information, and transfer-instruction details;
wherein remapping cost basis comprises identifying a total aggregate cost basis of each tax lot that was exchanged, calculating a per-share cost basis by dividing the total aggregate cost basis by an initial share price of the newly issued fund shares, and preserving an original acquisition date of the contributed securities by associating the original acquisition date with the new fund shares.

19. The system of claim 16, wherein calculating the total number of new fund shares comprises:
retrieving current market prices for each contributed security;
computing a market value for each contributed security by multiplying a share quantity by the current market price; and
summing market values across all contributed securities to obtain the aggregate market value.

20. The system of claim 16, wherein the instructions further cause the system to:
validate that a control group of contributing investors collectively owns at least a threshold ownership percentage of the new fund shares immediately after the exchange.

21. The system of claim 16, wherein generating securities-transfer instructions comprises:
formatting transfer data according to requirements of a destination custodian account via standardized electronic book-entry protocols comprising at least one of Automated Customer Account Transfer Service (ACATS), Fast Automated Securities Transfer (FAST), Direct Registration System (DRS), or Deposit & Withdrawal at Custodian (DWAC) protocols; and
transmitting the securities-transfer instructions to the destination custodian account to initiate delivery of new fund shares.
